(19) United States
(12) Patent Application Publication
(10) Pub. No.: US 2006/0150653 A1
(43) Pub. Date: Jul. 13, 2006

(54) Truck cooling system

(76) Inventor: Paul Anderson, Waco, TX (US)

Correspondence Address: ROBERT L. GREESON;7th Floor, 900 Washington Avenue, P.O. Box 1470, Waco, TX, 77603-1470, US

(21) Appl. No.: 11/033,045

(22) Filed: Jan. 11, 2005

(51) Int. Cl. B60H 1/32; F25D 17/04

(52) U.S. Cl. 62/239; 62/407

(57) ABSTRACT

An improved cab cooling system that operates by utilizing the conditioned air from a refrigerated trailer to cool the vehicle cab. As such, the energy from the vehicle engine is not relied upon. The apparatus is characterized by insulated and air tight components, which provides for tremendous operating efficiency. The apparatus has a connecting member that extends from a trailer cooling system, between the vehicle trailer and the cab, and into the cab cooling system. This apparatus is thought to be particularly useful in the context of the trucking industry.

### BACKGROUND OF THE INVENTION

1. Field of The Invention

The present invention generally relates to air conditioning systems. More specifically, the present invention relates to the air conditioning of truck cabs.

2. Background Information

Most ofthe consumer products we use today were, at one time or another, transported by truck. The trucking industry world-wide is vital to us as consumers and to our standard of living. And yet, at times, procedures used by the trucking industry are not as cost-effective as they could be. The current inefficiencies associated with current trucking industry methods have widespread, resounding effects. One such effect is an overall increase in price paid by the consumer.

An example of this inefficiency is seen in the method that is typically used to cool truck cabs during non-driving time. Truck drivers are required to rest a minimum of ten hours per day. During that period they are not allowed to drive their trucks. Depending on the route they are running and how far they are transporting their loads, this rest period may fall at a time when it is inconvenient or impossible to return to their homes or to stop at a hotel to rest. In addition, of course, the cost of a hotel room can be high. Typically, the truck driver will spend this time sleeping in the cab of his truck, which is equipped with a bed. The problem is that in hot weather the cab of the truck would get very hot if the engine were turned off. The engine of the truck typically powers the air conditioning unit in the cab and cools the cab.

When the truck is being driven, of course, this procedure works fine and is cost effective. But when the truck is not being driven and is instead idling, it takes approximately one and a half gallons of fuel per hour simply to cool the cab. At ten hours per day and approximately two dollars per gallon, this is thirty dollars per day simply for the comfort of the driver. Over the period of a year (approximately 200 working days) this associated expense approaches six thousand dollars!

In the case of refrigerated semi-trucks, an alternative exists that is much more cost effective. In a refrigerated semi-truck, there is a refrigeration unit cooling the trailer and its contents. The trailer must be cooled even during non driving times in order that the contents remain as fresh as possible. In the industry, cooling units such as a THERMO KING unit are commonly used to cool the trailer. A unit of this sort typically uses one gallon of fuel per hour to operate. For the same ten hours, then, and at approximately two dollars per gallon, it costs twenty dollars to run the THERMO KING unit. This expense is a constant and must be borne for the freshness of the product being transported and for consumer safety. It should be noted that the cooling units consumes approximately thirty three percent less fuel than the idling engine.

Currently, if a driver must pull off of the road and sleep in his cab, the trailer must continue to be cooled by the cooling unit. Meanwhile, the engine must idle in order to run the air conditioner located in the cab. If a way could be found to use a standard cooling unit to cool the cab of the truck, and at the same time cool the contents of the trailer, a huge savings could be reaped. At current costs this would represent a $6,000.00 per year savings for the truck company or truck owner. This savings is based on the typical 200 days a year that a semi-truck can operate and takes into account repair time and driver's days off.

In addition, newer THERMO KING cooling units use more technologically advanced power sources and produce lower exhaust emission levels, thereby being more environmentally friendly than an idling semi-truck engine. For example, the advanced THERM KING units make use of cryogenic liquids for refrigerant. These cryogenic units do not rely solely on diesel fuel, and have lower exhaust emission levels.

It is clear that there is a serious inefficiency in the way that the cab of a typical semi-truck is currently cooled during periods when the truck driver is resting and the present invention addresses this inefficiency.

### SUMMARY OF THE INVENTION

The general purpose of the present invention, which will be described subsequently in greater detail, is to provide an improved truck cooling system which has many of the advantages of such systems known in the art and many novel features that result in tremendous benefit which is not anticipated, rendered obvious, suggested, or even implied by any of the systems known in the art, either alone or in any combination thereof.

In view of the foregoing, it is an object of the present invention to provide an improved truck cooling system that is cost efficient.

It is another object of the present invention to provide an improved truck cooling system that establishes a significant reduction in operating costs in view of presently known systems.

It is another object of the present invention to provide an improved truck cooling system that is environmentally friendly.

It is another object of the present invention to provide an improved truck cooling system that makes use of cryogenic cooling fluids.

It is another object of the present invention to provide an improved truck cooling system that does not consume engine power during rest period use.

It is a yet another object of the present invention to provide an improved truck cooling system that does not exclusively rely on diesel fuel consumption.

In satisfaction of these and other related objectives, Applicant's present invention provides for an improved truck cooling system. The present system employs a connection between a vehicle trailer and its cab. This connection utilizes the cooling effect of the refrigeration unit in a refrigerated semi-truck in order to comfortably cool the cab portion during non-driving times. As such, reliance on the idling engine is done away with.

The cab cooling system is placed in combination with the trailer cooling system. As mentioned, the trailer cooling system may be any standard cooling system as known in the art (such as a THERMO KING unit). In its most preferred form, a trailer cooling system that employs use of cryogenic resources is preferred (such as a THERMO KING ST-CR 300 unit), as such greatly reduces associated environmental impact and increases operating efficiency.

### BRIEF DESCRIPTION OF THE DRAWINGS

FIG. 1 is a top view of the improved vehicle cab cooling system of the present invention.

FIG. 2 is a perceptive view of components of the improved vehicle cooling system of the present invention.

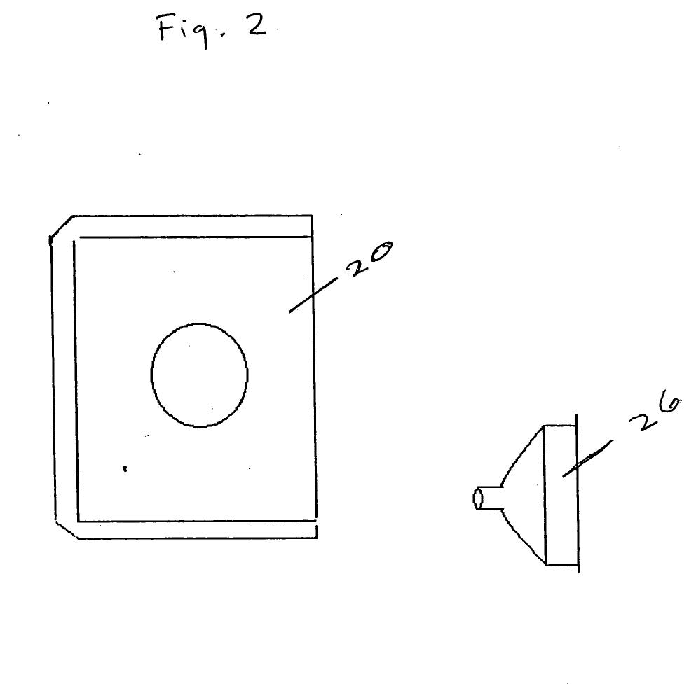

### DETAILED DESCRIPTION OF THE PREFERRED EMBODIMENT

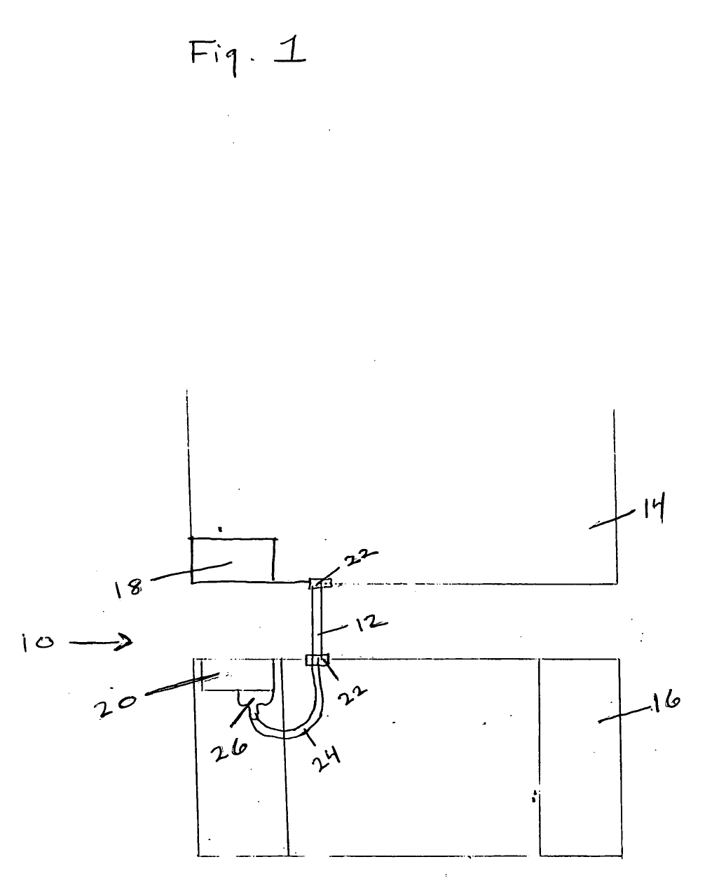

Referring to FIG. 1, the apparatus of the present invention is generally designated by the reference numeral 10. Device 10 is primarily characterized by a connection member 12, which extends between a trailer 14 and a cab 16. Also seen in FIG. 1 is trailer cooling system 18 and cab cooling system 20. In the preferred embodiment, trailer cooling system 18 and cab cooling system 20 may be any such standard cooling systems as known in the art. For instance, the present invention is thought to be most beneficial when used in conjunction with a trailer cooling system 18 such as a THERMO KING ST-CR 300 unit.

The primary function of connection member 12 is to provide a constant air-tight connection between the trailer 14 and cab 16, while allowing trailer 14 and cab 16 to move with respect to one another and allow conditioned air to flow there through. As such, in the preferred embodiment, connection member 12 is comprised of some flexible material such as rubber or soft plastic. Although not necessary, connection member 12 may be insulated with some material to further arrest energy loss and temperature change of the flowing conditioned air. Connection member 12 remains engaged with trailer 14 and cab 16 even when each is moving with respect to the other (i.e., while turning or going over bumps).

Attachment means 22 is located at each end of connection member 12. In the preferred embodiment, attachment means 22 fits member 12 and trailer 14, and member 12 and cab 16, so that an air-tight seal is formed there between. Such an air-tight fit ensures efficient operation of device 10. Finally attachment means may be of several configurations sure to be familiar to those skilled in the art. The most useful example of attachment means 22 include a gasket and sleeve combination, or some threaded fitting.

In the preferred embodiment, hose 24 extends from connection member 12 to trailer cooling unit 20. Hose 24 forms an air tight seal with connection member 12 at attachment means 22, as each is juxtaposed at a wall of cab 16. Hose 24 allows conditioned air to flow from connection member 12 into cab 16 in a confined and efficient manner. Further, in the preferred embodiment, hose 24 forms an air-tight connection with cab cooling system 20 via fitting 26. Fitting 26 receives hose 24 and mates with system 20. During operation the air flows from the output of trailer cooling system 18, through connection member 12, through hose 24 and into cab cooling system 20. At that point, conditioned air is circulated about cab 16. It is easily seen from this detailed description that the relatively small confines of cab 16 may be quickly and efficiently cooled using trailer cooling system 18 as the only resource. As mentioned, the monetary savings alone associated with use of the present invention strongly speaks to its novelty.

Importantly, the length and configuration of hose 24 may be adjusted so that air flowing therein may be manipulated in any number of fashions. As such, tremendous flexibility is provided with regard to the placement of the concentrated, cooled air. This is important as particularly useful embodiments are envisioned where hose 24 is of very short length and feeds directly into cab 16. Also, embodiments are envisioned where hose 24 is not present and conditioned air flows to a vent placed on a wall of cab 16. From there, the vent may be adjusted to manipulate the directional flow of incoming conditioned air.

Device 10 further lends itselfto various configurations as connection member 12 may be placed directly at the output of trailer cooling system 18 or at one of several locations in proximity thereof. If, for example, connection member 12 is placed at the output of cooling system 18, the conditioned air directly feeds to member 12. Also, for example, member 12 may be placed in proximity of trailer cooling system 18 so that as conditioned air flows past, it flows through member 12 and into cab 16. Finally, useful embodiments are envisioned where a pump or vacuum means is placed in combination with connection member where such is juxtaposed with trailer 14. Such pump or vacuum means would use a relatively small amount of energy, yet would increase the amount of conditioned air flowing into connection member 12.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

I claim:

1. A cooling apparatus, comprising:
a connecting member
generally configured to allow conditioned air to flow there through, and having a first end and a second end where said first end is configured to engage with a vehicle trailer, where said second end is configured to engage with a vehicle cab; and
an attachment means
positioned at said connecting member first end and said connecting member second end and configured to provide a substantially fluid tight fitting between said connecting member first end and said vehicle trailer and said connecting member second end and said vehicle cab.

2. The apparatus of claim 1, further comprising
a flexible hose
substantially disposed within said vehicle cab and extending from said connecting member second end and further configured to allow the egress of said conditioned air.

3. The apparatus of claim 1, further comprising
a vehicle trailer air conditioning means having a conditioned air output.

4. The apparatus of claim 1, where said connecting member first end is engaged with said vehicle trailer in proximity to said air condition means output.
